(19) United States
(12) Patent Application Publication
(10) Pub. No.: US 2004/0258858 A1
(43) Pub. Date: Dec. 23, 2004

(54) Ink jet recording sheet and production method of the same

(75) Inventors: Manabu Kaneko, Tokyo (JP); Yoshinori Tsubaki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/868,481

(22) Filed: Jun. 14, 2004

(30) Foreign Application Priority Data
Jun. 19, 2003 (JP) JP2003-174724

(51) Int. Cl. B41M 5/00

(52) U.S. Cl. 428/32.34

(57) ABSTRACT

An ink jet recording sheet is disclosed. The sheet has a porous ink receptive layer containing alumina particles or alumina hydrate particles and a hydrophilic binder which has undergone crosslinking employing ionization radiation.

### BACKGROUND OF THE INVENTION

The present invention relates to a production method of an ink jet recording sheet and in more detail to an ink jet recording sheet which comprises a support having thereon a porous layer which results in high printing density, excellent image bleeding resistance, and improved cracking resistance, as well as the production method of the same.

In recent years, in ink jet recording systems, image quality has quickly been improved and is approaching that of conventional silver salt photography. As a means to achieve such silver salt photographic quality by the use of ink jet recording systems, technical improvements have rapidly been made for the commonly employed ink jet recording sheets.

It is generally known that supports employed for ink jet recording sheets are comprised of water absorptive supports such as paper and non-water absorptive supports such as polyester film or resin coated paper. The former exhibits the advantage of high ink absorbability due to the fact that the support itself can absorb ink. On the contrary, however, problems occur in which wrinkling (also called cockling) after printing results due to water absorbability of the support, whereby it is difficult to produce high quality prints. In addition, problems occur in which the print surface, due to cockling during printing, tends to be rubbed by the ink jet head. To counter this, the use of non-water absorptive support referred to, as in the latter, does not result in the above problems and exhibits the advantage in which it is possible to produce high quality prints.

On the other hand, known is an ink jet recording sheet in which, for example, the ink receptive layer is formed by applying hydrophilic binders such as gelatin or polyvinyl alcohol onto a support at high smoothness. This type of recording sheet is called a swelling type ink jet recording sheet due to the use of an ink absorbing method utilizing swellability of binders.

However, in the above swelling type ink receptive layer, binders which constitute the layer are water-soluble resins, and the following problems occur. Desired drying properties after printing are not realized. The image layer is vulnerable to water, resulting in insufficient water resistance. Further, the rate of ink absorption due to swelling of binders is lower than that of ink ejection due to the high printing rate of the recent ink jet printers. As a result, ink flooding and image non-uniformity result due to a lack of adaptability, whereby the swelling type ink receptive layer is not suitable for high speed printing.

Japanese Patent Publication Open to Public Inspection (hereinafter referred to as JP-A) No. 63-18387 describes an ink receptive layer comprised of modified polyvinyl alcohol and water resistant additives. Further, proposed is a water-based ink recording sheet having an ink receptive layer comprised of hydrophilic resins which have undergone crosslinking utilizing ionization radiation (for example, Patent Document 1). As noted above, by employing cured binders as an ink receptive layer, the desired water resistance of images and layers is realized. However, by nature, since ink is absorbed utilizing the swellability of resins, ink absorbability is not improved.

Contrary to the above-mentioned swelling type ink jet recording sheet, in which ink is absorbed utilizing swellability of water-based resins, as described in JP-A No. 10-119423, a porous type ink jet recording sheet in which a porous layer having minute pores is provided as an ink receptive layer exhibits high ink absorbability as well as desired drying properties. As a result, a method using such an ink jet recording sheet is becoming one of the methods which result in image quality nearest to conventional silver salt photography.

The above-mentioned porous layer is formed mainly employing hydrophilic binders and minute particles. Known as minute particles, both inorganic and organic. However, minute inorganic particles are preferably employed due to their smaller particle diameter and realization of a porous layer of higher glossiness.

By employing hydrophilic binders in a relatively small amount with respect to the above minute inorganic particles, pores are formed among the minute inorganic particles and a porous layer at a high pores ratio is prepared.

The pores absorbs ink utilizing the capillary phenomenon. As a result, it exhibits an advantage such that even though water resistance is enhanced by crosslinking binders employing crosslinking agents, the absorption rate is not lowered. Specifically, in the case of an ink jet recording sheet in which such a porous layer is provided on a non-water absorptive support, such as polyethylene coated paper, which is prepared by coating both sides of a paper support with polyethylene resins, during ink jet printing, it is necessary that all the ink is temporarily retained in the ink receptive layer. As a result, it is essential that the ink receptive layer is a porous layer having a high pore volume, whereby it is necessary to form a thick coated layer at a high pores ratio. The thickness of the dried layer is preferably 25-50 μm, but is more preferably 30-50 μm.

The main components of the porous layer having such features are commonly minute inorganic particles, which originally form a hard coating layer. As a result, when a relatively thick porous layer is applied onto a non-water adsorptive support, cracking tends to occur during drying.

During the production process of the porous layer, hydrophilic binders in a relatively small amount adhere to the surface of the minute particles, and thereby the minute particles are intertwined among hydrophilic binders. Otherwise, minute particles are retained via interaction such as hydrogen bonds between hydrophilic binders to form protective colloids, whereby a porous layer is formed. Thereafter, it is assumed that during the drying process, rapid contraction of the coating occurs, resulting in cracking on the layer surface due to the subsequent contraction stress. Specifically, the phenomena are pronounced near the drying end point of the layer.

Thus, in order to prepare the desired coating which results in no cracking, it has been required that drying is carried out under relatively mild conditions at the sacrifice of productivity.

Further, in the ink receptive layer after drying, minute particles are only bound by hydrophilic binders in a relatively small amount. As a result, a problem of insufficient water resistance results.

In order to overcome such drawbacks, an ink jet recording sheet is proposed in which the water resistance of a layer is enhanced employing boric acid and isocyanate based crosslinking agents (for example, Patent Document 2). Further, an ink jet recording sheet is proposed in which an actinic radiation curable type monomer is employed as a binder (for example, Patent Document 3). On the other hand, a method is proposed in which, in an ink jet recording sheet in which an ink receptive layer and a gloss generating layer are successively provided, the gloss generating layer is comprised mainly of colloid particles and a hydrophilic ionization radiation curable compound having at least two ethylenic double bonds and curing is carried out through exposure to ionization radiation (for example, Patent Document 4).

When crosslinking agents are added to such hydrophilic binders, or actinic radiation curable monomers are employed as a binder, water resistance of the dried coated layer is enhanced due to the reaction between binders. However, since high density three-dimensional crosslinking is formed at a relatively short distance between the binders, new problems occur in which flexibility is deteriorated and further folding and cracking resistance of the coated layer (being an ink receptive layer) is degraded.

On the other hand, frequently employed as minute inorganic particles at relatively low cost are minute silica particles. For example, an ink jet recording sheet is known which is prepared by combining minute silica particles, synthesized employing a gas phase method, and colloidal silica with hydrophilic binders in a small amount. These minute silica particles do not exhibit ink fixability due to the fact that their surface is anionic. In order to provide water resistance and to minimize image bleeding during storage of prints, cationic fixing agents such as cationic polymers or multivalent metal salts have generally been required. However, even though such cationic fixing agents are used, the desired ink fixability has not been achieved. In addition, when a large amount of cationic fixing agent is added, problems occur in which the desired ink absorption is not achieved and in addition, cost increases.

(Patent Document 1)

JP-A No. 1-286886 (claims)

(Patent Document 2)

JP-A No. 2001-146068 (claims)

(Patent Document 3)

JP-A No. 7-40649 (claims)

(Patent Document 4)

Japanese Patent No. 3333338 (claims)

### SUMMARY OF THE INVENTION

In view of the foregoing problems, the present invention was achieved. An objective of the present invention is to provide an ink jet recording sheet (hereinafter also referred simply to as a recording sheet) which is comprised of an ink receptive layer comprising a porous layer wherein surface smoothness is excellent; desired surface appearance is achieved; the ink receptive layer exhibits excellent flexibility to result in desired cracking resistance; further, the ink receptive layer exhibits excellent ink absorbability to result in high printing density; and bleeding resistance of images is excellent, as well as a production method of the same.

The invention and its preferable embodiment are described.

1. An ink jet recording sheet comprising a support having thereon an ink receptive layer, wherein the ink receptive layer comprises a porous layer containing alumina particles or alumina hydrate particles and a hydrophilic binder which has undergone crosslinking employing ionization radiation.

The alumina particles or alumina hydrate particles preferably have an average secondary particle diameter of 10 to 300 nm.

The alumina particles or alumina hydrate particles preferably alumina particles or alumina hydrate particles have a specific surface area of 80 to 400 m²/g determined by BET method.

The alumina particles or alumina hydrate particles preferably are those synthesized via gas phase method.

The support is preferably a non-ink absorptive support.

A production method of the ink jet recording sheet mentioned above, which comprises;

applying a dispersion comprising alumina particles or alumina hydrate particles and a hydrophilic binder capable of cross-linking via ionization radiation onto the support to form a coated layer, and

irradiating the coated layer via ionization radiation.

In the production method stated above, ionization radiation is preferably carried out at an exposure energy of 0.1 to 100 mJ/cm² at a wavelength of 350 nm employing a metal halide lamp having a dominant luminous wavelength of 300 to 400 nm.

The preferable hydrophilic binder is water-soluble before ionization radiation and turns water-insoluble via ionization radiation.

The preferable hydrophilic binder is a polyvinyl alcohol partially modified with a group capable of crosslinking reaction via ionization radiation.

The degree of polymerization of the hydrophilic binder is preferably at least 500. And the modification ratio of a crosslinking group is preferably 0.01 to 4 mol percent based on a total mol of the hydrophilic binder.

The preferable example of the group capable of crosslinking reaction via ionization radiation is a photodimerization group, a photodecomposition group, a depolymerization group, a photomodification group or a photopolymerization group.

The preferable example of the hydrophilic binder comprises a resin comprising structure of the formula (2) in a polyvinyl alcohol structure,

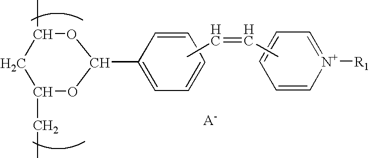

wherein R₁ represents an alkyl group having 1 to 4 carbon atoms and A⁻ represents an anionic group.

The molar ratio of the structure of the formula (2) to polyvinyl alcohol structure is preferably 0.01 to 4 percent.

The other preferable example of the hydrophilic binder comprises a resin comprising structure of the formula (2) in a polyvinyl alcohol structure,

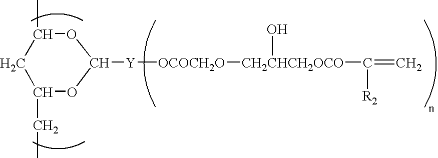

wherein R₂ represents a hydrogen atom or a methyl group, Y represents an aromatic ring or a single bonding means, and n represents 1 or 2.

The molar ratio of the structure of the formula (2) to polyvinyl alcohol structure is preferably 0.01 to 4 percent.

Other preferable embodiments are described.

1. An ink jet recording sheet which comprises a support having thereon an ink receptive layer comprised of a porous layer containing alumina, or alumina hydrate, at an average secondary particle diameter of 10-300 nm, and a hydrophilic binder which has undergone crosslinking employing ionization radiation.

2. An ink jet recording sheet which comprises a support having thereon an ink receptive layer comprised of a porous layer containing alumina, or alumina hydrate, at a specific surface area of 80-400 m²/g, determined by the BET method, and a hydrophilic binder which has undergone crosslinking employing ionization radiation.

3. An ink jet recording sheet which comprises a support having thereon an ink receptive layer comprised of a porous layer containing alumina, or alumina hydrate, at an average secondary particle diameter of 10-300 nm, and at a specific surface area of 80-400 m²/g, determined by the BET method, and a hydrophilic binder which has undergone crosslinking employing ionization radiation.

4. The ink jet recording sheet described in any one of 1.-3. above wherein the aforesaid alumina is synthesized employing a gas phase method.

5. The ink jet recording sheet described in any one of 1.-4. above wherein the degree of polymerization of the aforesaid binder, which undergoes crosslinking employing ionization radiation, is at least 500 and the modification ratio of a crosslinking group is 0.01-4 mol percent.

6. The ink jet recording sheet described in any one of 1.-5. above wherein the aforesaid support is a non-ink absorptive support.

7. A production method of the ink jet recording sheet described in any one of 1.-6. wherein an ink receptive layer comprised of a porous layer is formed in such a manner that after application onto a support a dispersion comprising alumina or alumina hydrate, and a hydrophilic binder which undergoes crosslinking employing ionization radiation, the resulting coating is exposed to ionization radiation at an exposure energy of 0.1-100 mJ/cm² at a wavelength of 350 nm employing a metal halide lamp having a dominant luminous wavelength of 300-400 nm, and the coating is subsequently dried.

### DESCRIPTION OF THE INVENTION

The inventors of the present invention discovered that by applying onto a support an ink receptive layer comprised of a porous layer containing alumina or alumina hydrate at an average secondary particle diameter of 10-300 nm, as well as a hydrophilic binder which had undergone crosslinking employing ionization radiation, a porous layer containing alumina or alumina hydrate at a specific surface area of 80-400 m²/g, determined by the BET method, as well as a hydrophilic binder which had undergone crosslinking employing ionization radiation, or a porous layer containing alumina or alumina hydrate at an average secondary particle diameter of 10-300 nm, as well as at a specific surface area of 80-400 m²/g, determined by the BET method, and a hydrophilic binder which had undergone crosslinking employing ionization radiation, it was possible to realize an ink jet recording sheet wherein surface smoothness was excellent; desired surface appearance was achieved; cracking tended to not result on the surface during production; the porous layer exhibited excellent flexibility; further the ink receptive layer exhibited excellent ink absorbability to result in high printing density; and bleeding resistance of images was excellent.

Further, by employing the aforesaid alumina which has been synthesized employing a gas phase method, the aforesaid hydrophilic binders at a degree of polymerization of at least 500 and a modification ratio of the crosslinking group of 0.01-4 mol percent, which have undergone crosslinking employing ionization radiation, and the aforesaid support which is non-ink absorptive, the above effects are more pronounced.

Still further, it is possible to produce a recording sheet which satisfies the aforementioned characteristics by forming a porous layer in such a manner that after applying onto a support a dispersion comprising alumina or alumina hydrate, as well as a hydrophilic binder which undergoes crosslinking employing ionization radiation, the resulting coating is exposed to ionization radiation at an exposure energy of 0.1-100 mJ/cm² at a wavelength of 350 nm employing a metal halide lamp having a dominant luminous wavelength of 300-400 nm, and subsequently dried.

The present invention will now be detailed.

<Alumina>

Generally listed as alumina are minute particles of alumina or alumina hydrate prepared as follows. One is gas phase method alumina which is prepared in such a manner that gaseous aluminum chloride is hydrolyzed at high temperature together with hydrogen and oxygen under thermal combustion. The other is so-called wet process alumina which is prepared employing a method in which aluminates are hydrolyzed and combusted. Properties of the minute particle of each of gas phase method alumina, and wet process alumina and alumina hydrate are closely related to their specific surface area and structure.

It is possible to determine the specific surface area of minute particles, employing the BET method.

Minute particles themselves of alumina and alumina hydrate result in ink fixability. Consequently, it is possible to enhance ink fixability without adding cationic fixing agents which result in non-uniformity as well as bronzing during printing. Almost all the colorants used in ink jet inks are anionic, while the surface of alumina and alumina hydrate is cationic, whereby colorants are adsorbed onto the surface of these particles and fixed. The amount capable of adsorbing the colorants depends on the specific surface area of the particles.

Further, alumina and alumina hydrate posses a reactive hydroxyl group on their particle surfaces. Interaction among minute particles results due to the hydrogen bond of the hydroxyl group, whereby three-dimensional pores are formed. Ink is absorbed into the resulting pores to increase the ink absorption amount, whereby ink absorbability is enhanced.

The specific surface area of many wet process alumina and alumina hydrate is 200-400 m²/g. Due to the production process, many pores exist in the interior of particles to result in a large interior surface area. Namely, this indicates that there are many pores which are adsorbed by ink colorants but the number of hydroxyl groups capable of forming a hydrogen bond among particles is relatively small due to the fact that many of the pores are located in the interior of particles, whereby it is assumed that formation of pores becomes difficult to result in the decrease in an ink absorption amount.

On the other hand, in gas phase method alumina, negligible number of pores exit in the interior and nearly all pores on the particle surface face outward. As a result, the number of hydroxyl groups which result in the hydrogen bond among particles is greater than wet process alumina and alumina hydrate, whereby pores are easily formed.

Employed as alumina and alumina hydrate employed in the present invention may be gas phase method alumina, and wet process alumina and alumina hydrate. However, in view of ink absorbability, preferred is gas phase method alumina or pseudo-boehmite, of which gas phase method alumina is more preferred.

Alumina or alumina hydrate at a specific surface area of 80-400 m²/g is preferably employed. However, it is more preferable to use gas phase method alumina at a specific surface area of 120-250 m²/g because ink absorbability as well as image bleeding resistance is improved.

Namely, the gas phase method alumina at a specific surface area of 120-250 m²/g is preferred due to the fact that the ink absorbability is more improved; the bleeding resistance of images is also more enhanced; interaction among minute particles is more controllable; handling in the form of powder is easier; the viscosity of the dispersed liquid composition is lower; and high speed coating is more achievable due to excellent dispersion stability.

In the case of using gas phase method alumina, it is preferable that the pH of the resulting dispersion is 3-5. By controlling the pH of dispersions is to 3-5, interaction among particles becomes controllable to improve dispersion properties whereby it is possible to prepare a dispersion at a solid concentration of at least 30 percent. Further standing stability of the resulting dispersion is improved and still further, it is possible to maintain high ink absorbability.

In the dispersion of alumina or alumina hydrate used in the present invention, a plurality of primary particles is combined to form the secondary particles. It is possible to control the diameter of the secondary particles by varying the dispersion time and dispersion conditions of homogenizers. In view of ease of handling, dispersion properties, dispersion stability, ink absorbability, and glossiness, the average diameter of the primary particles of alumina or alumina hydrate is preferably 5-30 nm, while in view of ease of handling and dispersion properties, it is more preferably 7-12 nm. Further, in view of the transmission of ionization radiation given to the resulting coating, the secondary particle diameter is preferably 10-300 nm, and is more preferably 50-200 nm.

The average primary particle diameter of alumina or alumina hydrate is determined as follows. The powders themselves or the cross section or surface of a recording sheet is observed employing an electron microscope, and the diameter of each of 1,000 randomly selected particles is recorded. Herein, each particle diameter is expressed by the diameter of a circle having the same projected area as that of each particle.

<Hydrophilic Binders>

The recording sheet of the present invention comprises, in the porous layer, hydrophilic binders which have undergone crosslinking employing ionization radiation.

Hydrophilic binders which undergo crosslinking employing ionization radiation, as described herein, refer to water-soluble resins which undergo reaction resulting in crosslinking by exposure to ionization radiation such as ultraviolet radiation or electron beams. As noted above, prior to curing reaction, they are water-soluble resins, while after curing reaction, they become water-insoluble resins. Incidentally, after curing, the above-mentioned resins exhibit hydrophilicity and sufficient affinity to inks.

Examples of the resin is a polyvinyl alcohol a part of which is modified with a group undergo reaction resulting in crosslinking by exposure to ionization radiation, represented by Formula P.

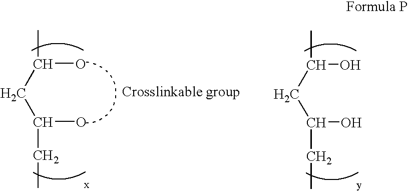

Employed as such resins may be crosslinking group modified polymers which undergo crosslinking via a modifying group employing ionization radiation while allowing any modifying group such as a photodimerization type, a photodecomposition type, a depolymerization type, a photomodification type, a photopolymerization type to act on polyvinyl alcohol (hereinafter also referred simply to as PVA). Of these, preferred are crosslinking group modifying groups having a photodimerization type or photopolymerization type modifying group.

Preferred as photodimerization type ionization radiation crosslinking type resins are those into which a diazo group, a cinnamoyl group, a stilbazonium group, or a stilquinolium group is introduced.

Specifically, listed may be photosensitive resins in which a stilbazonium group is introduced into a polyvinyl alcohol structure, represented by General Formula (1), described in JP-A No. 60-129742.

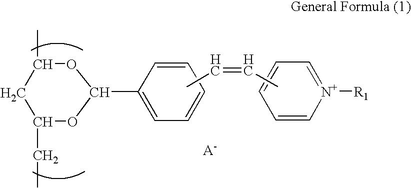

In General Formula (1), R₁ represents an alkyl group having 1-4 carbon atoms and A⁻ represents an anionic group.

Further, listed as photopolymerization type ionization radiation crosslinking type resins may be those represented by General Formula (2) below, described in JP-A No. 2000-181062.

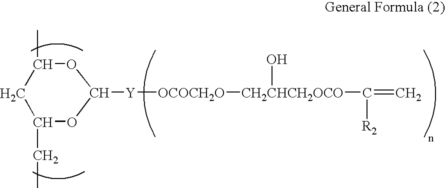

In General Formula (2), R₂ represents a hydrogen atom or a methyl group, Y represents an aromatic ring or a single bonding means, and n represents 1 or 2.

In hydrophilic binders, PVA which is a mother nucleus is preferably water-soluble. The degree of polymerization of PVA is preferably at least 500, and is more preferably at least 1,700, as far as it is soluble in water.

In hydrophilic binders, the modification ratio of the ionization radiation reactive crosslinking group to the segment, x/(x+y) in percent in Formula P, is preferably 0.01-4 mol percent, and is more preferably 0.01-1 mol percent.

By employing hydrophilic binders, a loose three-dimensional crosslinking structure is formed, whereby the desired cracking resistance of the dried coating and flexibility of the ink receptive layer are achieved.

<Preparation of Dispersion>

It is possible to prepare a dispersion comprised of alumina or alumina hydrate and hydrophilic binders as a main component by dispersing minute alumina particles or alumina hydrate particles into an aqueous hydrophilic binder solution, employing any homogenizer such as a high pressure type, a high speed stirring type, a sand mill type, or an ultrasonic type. Of these, the sand mill type is preferably employed to achieve dispersion. Beads employed in the above-mentioned sand mill are preferably made of zirconia, the preferable diameter being preferably 0.2-1.0 mm, and the more preferable diameter being 0.3-0.5 mm.

It is possible to simultaneously use other minute particles in the dispersion. Listed as simultaneously usable minute particles are, for example, precipitated calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica such as wet process silica or gas phase method silica, colloidal silica, zeolite, and magnesium hydroxide.

Further, it is possible to simultaneously use various other types of hydrophobic resins.

Still further, it is possible to add various types of additives. Examples of such additives include cationic mordants, crosslinking agents, surface active agents (e.g. cationic, nonionic, anionic and amphoteric surface active agents), white background tone control agents, optical brightening agents, mildewcides, viscosity control agents, low-boiling point organic solvents, high-boiling point organic solvents, latex emulsions, anti-discoloring agents, UV absorbers, multivalent metal compounds (being water-soluble or water-insoluble), photopolymerization initiators, optical sensitizers, matting agents, and silicone oils.

Employed as cationic mordants may be polymer mordants having a primary, secondary, and tertiary amino group and a quaternary ammonium salt group. Of these, preferred are polymer mordants having a quaternary ammonium salt group due to the fact that discoloration as well as degradation of lightfastness is minimized during extended storage and mordant capability is sufficiently high.

Preferred polymer mordants are prepared as homopolymers of monomers having a quaternary ammonium salt group, and copolymers or condensation polymers along with other monomers.

Preferably employed as multivalent metal compounds are, for example, sulfates, chlorides, nitrates, and acetates of Mg²⁺, Ca²⁺, Zn²⁺, Ni²⁺, and Al³⁺. Inorganic polymer compounds such as basic polyaluminum hydroxide and zirconyl acetate are included in the examples of preferred water-soluble multivalent metal compounds.

Listed as photopolymerization initiators and optical sensitizers are, for example, benzophenones (e.g. benzophenone, hydroxybenzophenone, bis-N,N-dimethylaminobenzophenone, bis-N,N-diethylaminobenzophenone, and 4-methoxy-4′-dimethylaminobenzophenone), thioxanthones (e.g. thioxanthone, 2,4-diethylthioxanthone, isopropylthioxanthone, chlorothioxanthone, and isopropoxychlorothioxanthone), anthraquinones (e.g. ethylanthraquinone, benzanthraquinone, aminoanthraquinone, and chloroanthraquinone), acetophenones, benzoin ethers (e.g. benzoin methyl ether), 2,4,6-trihalomethyltriazines, 1-hydroxycylohexyl phenyl ketone, 2-(o-chlorophenyl)-4,5-diphenylimidazole dimers, 2-(o-chlorophenyl)-4,5-di(m-methoxyphenyl)imidazole diners, 2-(o-fluorophenyl)-4,5-phenylimidazole diners, 2-(o-methoxyphenyl)-4,5-phenylimidazole diners, 2-(p-methoxyphenyl)-4,5-diphenylimidazole diners, 2,-di(p-methoxyphenyl)-5-phenylimidazole dimers, 2,4,5-triarylimidazole diners, 2-(2,4-dimethoxyphenyl)-4,5-diphenylimidazole dimer, benzyldimethylketal, 2-benzyl-2-dimethylamino-1-(4-morpholinophenyl)-butane-1-one, 2-methyl-1-[4-(methylthio)phenyl]-2-morpholino-1-propane, 2-hydroxy-2-methyl-1-phenyl-propane-1-one, 1-[4-(2-hydroxyethoxy)-phenyl]-2-hydroxy-2-methyl-1-propane-1-one, phenanthrenequinone, 9,10-phenanthrenequinone, benzoins (e.g. methylbenzoin and ethylbenzoin), acridine derivatives (e.g. 9-phenylacridone, 1,7-bis(9,9′-acrydinyl)heptane), and bisacylphosphine oxide. The above compounds may be employed individually or in combination.

In addition to photopolymerization initiators, it also is preferable to add polymerization accelerators. Listed as polymerization accelerators may be, for example, ethyl p-dimethylaminobenzoate, isoamyl p-dimethylaminobenzoate, ethanolamine, diethanolamine, and triethanolamine.

<Production of Recording Sheets>

In the present invention, it is possible to produce a recording sheet in such a manner that after applying dispersion onto a support, the resulting coating is exposed to ionization radiation and subsequently dried.

<<Coating of Dispersion>>

During the coating operation, it is preferable that coating is carried out to result in a coating weight of alumina or alumina hydrate of preferably 5-40 g/m² and more preferably 7-30 g/m². In the above coating weight range, desired ink absorbability as well as sufficient printing density is achieved during printing.

In a porous coating layer, the weight ratio of alumina or alumina hydrate to the hydrophilic binders is preferably 2-50, and is more preferably 5-15. At the above ratio, it is possible to secure sufficient pore volume in the porous layer, as a result, ink is sufficiently absorbed. Further, even though a relatively thick layer is applied, it is possible to achieve sufficient resistance to cracking, whereby it is possible to prepare a desirably flexible recording sheet.

It is preferable that the pore volume of the porous layer remains within 15-40 ml per m² of the coating. By controlling the pore volume within the above values, it is possible to achieve desired ink absorbability.

Pore volume, as described herein, refers to the volume of air bubbles which are generated during immersion of the coating of unit volume, or the volume of water which can be absorbed by the coating. Alternatively, it is defined as a liquid transfer amount during contact time of 2 seconds when measured in accordance with Paper and Paperboard Liquid Absorbability Test Method (Bristow's Method) specified in J. TAPPI 51.

During production of the recording sheet of the present invention, preferably employed methods to apply a dispersion onto a support include a gravure coating method, a roll coating method, a rod bar coating method, an air knife coating method, a spray coating method, an extrusion coating method, a curtain coating method, or an extrusion coating method employing a hopper, described in U.S. Pat. No. 2,681,294.

A porous layer may be comprised of a single layer or at least two layers. When comprised of at least two layers, the constitution of these layers may be the same or different. Further, when comprised of at least two layers, from the viewpoint of productivity, it is preferable that all the constituting layers are simultaneously applied.

<<Ionization Radiation Exposure>>

After coating, the resulting coating is exposed to ionization radiation so that hydrophilic binders capable of undergoing crosslinking by exposure to ionization radiation undergo crosslinking to become water-insoluble.

Specifically employed as sources for ionization radiation are low, medium, and high pressure mercury lamps at an operation voltage of several kPa—several MPa, and metal halide lamps. Of these, in view of wavelength distribution and output, high pressure mercury lamps as well as metal halide lamps are acceptable, but metal halide lamps are more preferred.

Preferred as the above radiation sources are those at an output of 400 W-30 kW and an illuminance of 10 mW/cm²-10 kW/cm². Further, it is preferable that the radiation source is provided with a filter which removes radiation of a wavelength shorter than 300 nm.

In the present invention, it is preferable that a metal halide lamp having a dominant emission wavelength of 300-400 nm is employed as an ionization radiation source and exposure energy at a wavelength of 350 nm is set at 0.1-100 mJ/cm².

Through exposure to ionization radiation under the above conditions, it is possible to sufficiently promote crosslinking reaction to achieve the objective of the present invention without decomposing the hydrophilic binders.

<Supports>

Employed as supports used for the recording sheets of the present invention may be ink absorptive supports (for example, paper) and non-ink absorptive supports. However, in view of enabling preparation of higher quality prints, the non-ink absorptive support is more preferred.

Listed as preferably employed non-water absorptive supports are, for example, polyester based film, diacetate based film, triacetate based film, polyolefin based film, acryl based film, polycarbonate based film, polyvinyl chloride based film, polyimide based film, transparent or opaque film comprised of materials such as cellophane or celluloid, and so-called RC paper prepared by coating both sides of a paper substrate with polyolefin resins.

In order to apply a dispersion onto a support, it is preferable that to enhance adhesion between the support surface and the coating layer, the support surface is subjected to corona discharge treatment and subbing treatment. Further, the recording sheet of the present invention may comprise a colored support.

Supports preferably employed in the present invention include transparent polyester film, opaque polyester film, opaque polyolefin resin film, and a paper support which is laminated on both sides with polyolefin resins.

A non-ink-absorptive paper support will now be described which is laminated on both sides with polyethylene which is representative of the most preferred polyolefin resins.

Base paper employed for the paper supports is made employing wood pulp as the major raw material, and if desired, employing synthetic pulp such as polypropylene, or synthetic fiber such as nylon or polyester in addition to wood pulp.

The basic weight of base paper is preferably 30-250 g, and is particularly preferably 50-200 g. The thickness of base paper is preferably 40-250 μm. Base paper may be calendered during or after paper manufacture to result in higher smoothness. The density of base paper is customarily 0.7-1.2 g/cm² (based on the method specified in JIS P 8118).

Further, the stiffness of base paper is preferably 20-200 g under conditions specified in JIS P 8143. Surface sizing agents may be applied onto the surface of base paper. Employed as surface sizing agents may be the same ones as those which can be incorporated into the above-mentioned base paper. The pH of base paper, when determined by the hot water extraction method specified in JIS P 8113, is preferably 5-9.

Polyethylene which is employed for coating both sides of the paper is mainly comprised of low density polyethylene (LDPE) and/or high density polyethylene (HDPE). However, it is possible to partly use LLDPE and polypropylene.

It is preferable that opacity and whiteness of the polyethylene layer to be coated with an ink receptive layer are improved by incorporation of anatase type titanium dioxide. The proportion of titanium oxide is preferably 1-20 percent by weight with respect to polyethylene, and is more preferably 2-15 percent by weight.

Polyethylene coated paper may be employed as glossy paper. Further, while coating polyethylene onto the surface of base paper via melt-extrusion, a so-called embossing process may be carried out and matte or silk surfaced paper, as prepared for common photographic paper, may be employed.

It is preferable that the thickness of a polyethylene layer on the surface to be coated with an ink receptive layer is 20-40 μm, while the thickness on the surface to be coated with a back layer is 10-30 μm.

It is preferable that the above-mentioned polyethylene coated supports exhibit the following characteristics.

1) Tensile strength: Tensile strength specified in JIS P 8113 is preferably 20-300 N in the longitudinal direction and 10-200 N in the lateral direction.

2) Tear strength: Tear strength specified in JIS P 8116 is preferably 0.1-2 N in the longitudinal direction and 0.2-2 N in the lateral direction.

3) Compression modulus of elasticity: ≧1,030 N/cm²

4) Obverse surface Bekk smoothness: A glossy surface preferably results in at least 500 seconds under conditions specified in JIS P 8119, while an embossed surface may be at most 500 seconds.

5) Reverse surface Bekk smoothness: preferably 100-800 seconds under conditions specified in JIS P 8119

6) Opacity: When determined under conditions of linear incident light/scattered light transmission, transmittance in the visible region is preferably at most 20 percent, and is more preferably at most 15 percent.

7) Whiteness: Hunter whiteness specified in JIS P 8123 is preferably at least 90 percent. Further, when determined based on JIS Z 8722 (non fluorescence) and JIS Z 8717 (containing phosphors), and expressed by the color specification method specified in JIS Z 8730, L*, a*, and b* are preferably from 90 to 98, from −5 to +5, and from −10 to +5, respectively.

For enhanced adhesion of the ink receptive layer on both sides of the above-mentioned support, it is possible to provide a subbing layer. Preferred binders for the subbing layer include hydrophilic polymers such as gelatin or polyvinyl alcohol and latex polymers of a Tg of −30-60° C. The coated amount of these binders is preferably 0.001-2 g per m² of the recording sheet. For antistatic purposes, it is possible to incorporate prior art antistatic agents such as cationic polymers in a relatively small amount.

To improve slippage properties as well as electrostatic characteristics of the above-mentioned supports, it is preferable to provide a back layer on the surface opposite the surface to be coated with an ink absorptive layer. Preferred as binders of the back layer are hydrophilic polymers such as gelatin or polyvinyl alcohol and latex polymers at a Tg of −30-60° C. Further, it is possible to incorporate antistatic agents such as cationic polymers, various surface active agents, and matting agents at an average particle diameter of 0.5-20 μm. The thickness of the back layer is preferably 0.1-1 μm. When the back layer is provided to minimize curling, the above thickness is preferably 1-20 μm, even though it varies depending on the thickness of the ink receptive layer. Further, the back layer may be comprised of at least two layers.

<Ink>

When recording (printing) images employing the recording sheet of the present invention, it is preferable to use ink jet ink.

Ink jet ink, as described herein, refers to water-based ink comprising colorants, liquid media, and other additives. Preferred as ink is one which is not absorbed into the support.

Preferably employed as colorants are water-soluble dyes such as direct dyes, acid dyes, basic dyes, reactive dyes, or food dyes and water-dispersible pigments, which are employed for ink jet printing.

Preferred as liquid media are those which are mainly comprised of water and various water-soluble organic solvents. Organic solvents are not particularly limited as long as they are not absorbed by the supports employed in the present invention. For example, preferably employed are alcohols such as methyl alcohol, isopropyl alcohol, butyl alcohol, tert-butyl alcohol, or isopropyl alcohol; amides such as dimethylformamide or dimethylacetoamide; ketones or ketone alcohols such as acetone or acetone alcohol; ethers such as tetrahydrofuran or dioxane; polyalkylene glycols such as polyethylene glycol or polypropylene glycol; polyhydric alcohols such as ethylene glycol, propylene glycol, butylene glycol, triethylene glycol, 1,2,6-hexanetriol, thiodiglycol, hexylene glycol, diethylene glycol, glycerin, or triethanolamine; as well as lower alkyl ethers of polyhydric alcohols such as ethylene glycol trimethyl ether, diethylene glycol methyl (or ethyl) ether, or triethylene glycol monobutyl ether. Of these, preferably employed are polyhydric alcohols such as diethylene glycol, triethanolamine, or glycerin and lower alkyl ether of polyhydric alcohols such as triethylene glycol monobutyl ether.

Listed as other additives are, for example, pH control agents, metal sequestering agents, mildewcides, viscosity control agents, surface tension control agents, humectants, surface active agents, and anti-corrosive agents. If required, it is preferable that any of these may be employed via addition.

In order to improve wettability of water-based ink onto the ink receptive layer, its surface tension at 20° C. is preferably 0.025-0.06 N/m, and is more preferably 0.03-0.05 N/m. Further, the pH of the water-based ink is preferably 5-10, and is more preferably 6-9.

### EXAMPLES

The effects of the present invention will now be described with reference to examples. “%” described in the examples is “% by weight”, unless otherwise noted.

(Preparation of Minute Particle Dispersions S-1-S-8)

Aluminum chloride was vaporized, and treated at a high temperature in the presence of oxygen and hydrogen, whereby 250 g of gas phase method alumina at a specific surface area of 130 m²/g (determined by the BET method) was prepared. The resulting alumina was gradually added to 800 ml of pure water employing a high speed stirring homogenizer while maintaining the pH at 4.6 by the addition of nitric acid. After finally adding 60 ml of a 4% aqueous boric acid solution, the pH of the resulting mixture was adjusted to 4.5 by the addition of nitric acid, and the total volume was brought to 1,000 ml by the addition of pure water. Subsequently, the resulting liquid composition was dispersed employing a sand mill, whereby gas phase method alumina “Minute Particle Dispersion S-1” was prepared.

By employing each of the gas phase method alumna at a specific surface area of 100 m²/g, alumina hydrate (pseudo-boehmite) at a specific surface area of 250 and 450 m²/g, and alumina which was prepared by hydrolyzing and burning aluminum alkoxide at a specific surface area of 60 and 90 m²/g, dispersion was carried out in the same manner as above, employing a sand mill while varying the dispersion time, whereby “Minute Particle Dispersions S-2-S-8” described in Table 2 were prepared.

(Preparation of Minute Particle Dispersion S-9)

Gradually added to 800 ml of a 1% aqueous methanol solution of which pH had been adjusted to 4 by adding nitric acid was 250 of silica at a specific surface area of 200 m²/g produced by a gas phase method, employing a high speed stirring homogenizer, and thereafter, the total volume was brought to 1,000 ml by adding water. Subsequently, the resulting liquid composition was dispersed employing a sand mill, whereby “Minute Particle Dispersion S-9” listed in Table 2 was prepared

Table 1 shows the employed minute inorganic particles and their specific surface area.

TABLE 1

| Minute | | Specific |
|---|---|---|
| Inorganic | Minute Inorganic | Surface Area |
| Particle No. | Particle | (m²/g) |
| 1 | Gas Phase Method | 130 |
| | Alumina | |
| 2 | Gas Phase Method | 100 |
| | Alumina | |
| 3 | Alumina Hydrate | 250 |
| | (pseudo-boehmite) | |
| 4 | Alumina Hydrate | 450 |
| | (pseudo-boehmite) | |
| 5 | Alumina (*1) | 60 |
| 6 | Alumina (*1) | 90 |
| 7 | Silica (*2) | 200 |

*1: Alumina which was prepared by hydrolyzing and burning aluminum alkoxides
*2: Silica produced by a gas phase method

(Preparation of Recording Sheets A-1-A-9)

While stirring, gradually added to 130 ml of each of “Minute Particle Dispersion S-1-S-9” were 40 g of an aqueous solution of an ionization radiation crosslinking type polyvinyl alcohol derivative (represented by Formula (6), at a degree of polymerization of the main chain of 3,000, a saponification ratio of 88%, and a crosslinking modification ratio of 1 mol %) of which concentration was controlled to be 10% by weight and 0.06 g of photopolymerization initiator “KAYACURE QTX”, manufactured by Nippon KAYAKU Co., Ltd., and the volume of the resulting mixture was brought to 300 ml by the addition of water, whereby an ink receptive layer dispersion was prepared.

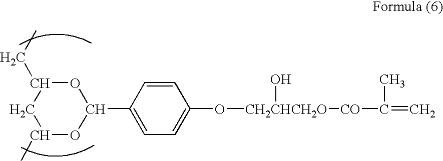

Subsequently, the above-mentioned ink receptive layer dispersion was applied onto polyethylene coated paper, which was prepared by coating both sides of 170 g/m² base paper with polyethylene at a wet layer thickness of 180 μm, employing a bar coater. Thereafter, the resulting coating was exposed to ionization radiation at an illuminance of 100 mw/cm², employing a metal halide lamp having a dominant wavelength of 365 nm, fitted with filter “365 Filter” (manufactured by Iwasaki Electric Co., Ltd.), so that the energy amount reached 30 mJ/cm². Thereafter, drying was carried out employing a hot air type oven, whereby “Recording Sheets A-1-A-9” comprising an ink receptive lawyer, being a porous layer, were prepared.

The above-mentioned polyethylene coated paper was constituted as follows. Polyethylene on the ink receptive layer side contained 8% anatase type titanium oxide. On the ink receptive layer side, was a gelatin sublayer at a thickness of 0.05 g/m². On the side opposite the ink receptive layer side, was a back layer comprising latex polymer at a Tg of approximately 80° C. at a coating thickness of 0.2 g/m².

(Preparation of Recording Sheet B-1)

“Recording Sheet B-1” was prepared in the same manner as “Recording Sheet A-1” above, except that the ionization radiation crosslinking type polyvinyl alcohol derivative at a degree of polymerization of the main chain PVA was replaced with an ionization radiation crosslinking type polyvinyl derivative at a degree of polymerization of the main chain of 300.

(Preparation of Recording Sheet C-1)

“Recording Sheet C-1” was prepared in the same manner as “Recording Sheet A-1” above, except that the ionization radiation crosslinking type polyvinyl alcohol derivative at a crosslinking group modification ratio of 1 mol % was replaced with an ionization radiation crosslinking type polyvinyl alcohol derivative at a crosslinking group modification ratio of 5 mol %.

(Preparation of Recording Sheet D-1)

“Recording Sheet D-1” was prepared in the same manner as “Recording Sheet A-3” above, except that the metal halide lamp having a dominant wavelength of 365 nm was replaced with a low pressure mercury lamp having a dominant wavelength of 254 nm and the energy amount was changed from 30 mJ/cm² to 110 mJ/cm².

(Preparation of Recording Sheet E-1)

“Recording Sheet E-1” was prepared in the same manner as “Recording Sheet A-3” above, except that the employed ionization radiation crosslinking type polyvinyl alcohol derivative was replaced with polyvinyl alcohol (at a degree of polymerization of 3,000 and a saponification ratio of 88%), 0.03 g of boric acid was added, and exposure to ionization radiation was omitted.

Subsequently, each of the recording sheets prepared as above was stabilized while stored at 40° C. for three days.

(Evaluation of Each of the Characteristics of Each of Recording Sheets)

Each of the recording sheets prepared as above was evaluated for each characteristic item based on the methods described below.

(Average Secondary Particle Diameter)

The average secondary particle diameter was a value determined employing the above-mentioned method which was observed employing an electron microscope.

(Evaluation of Smoothness)

The center line surface roughness (measured at a standard length of 2.5 mm and a cut-off value of 0.8 mm in all cases) of the surface of each ink receptive layer prepared as above was determined in accordance with the method specified in JIS B 0601, and smoothness was evaluated based on the criteria below.

Evaluation Criteria

A: center line surface roughness Ra was less than 1.0 μm and the appearance was excellent

B: center line surface roughness Ra was 1.0-1.5 μm and the appearance was good

C: center line surface roughness Ra was at least 1.5 μm and the appearance was degraded, resulting in problems of commercial viability

D: formation of many cracks on the entire surface of the coating was visually observed, resulting in no commercial viability

In the above evaluation, ranks A and B were judged to be commercially viable.

(Evaluation of Cracking Resistance)

The surface of the ink receptive layer of each recording sheet prepared as above was observed employing a hand magnifier, and the cracks on the layer surface generated within 10 cm² were counted. The resulting number was employed as the scale for cracking resistance.

Evaluation Criteria

A: the number of cracks was at most 3 and the appearance was excellent

B: the number of cracks was 4-10 and the appearance was good

C: the number of cracks was 11-20 and the appearance was Degraded, resulting in a slight problem of commercial viability

D: the number of cracks was at least 21, resulting in no commercial viability

In the above ranks, ranks A, B, and C were judged to be at a level of commercial viability.

(Evaluation of Ink Absorbability)

A solid neutral gray image at a reflection density of approximately 1.0 was printed employing “Ink Jet Printer PM800C” (manufactured by Seiko Epson Corp.), and ink absorbability was evaluated based on the criteria below.

Evaluation Criteria

A: no generation of non-uniformity on the solid image surface was noted, resulting in excellent quality

B: slight non-uniformity on the solid image surface was noted, resulting in quality without any problems for commercial viability

C: under careful observation of the solid image surface was generation of distinguishable non-uniformity was noted, however still at a quality of viable commercial prints

D: mottled gray color was clearly noted on the solid image surface, resulting in no commercial viability

E: mottled color was noted on the solid image surface, resulting in complete commercial non-viability

In the above ranks, rank C or above was judged to be commercial viable.

(Evaluation of Flexibility of the Ink Receptive Layer)

Each of the above recording sheets was cut into 5×10 cm strips. Each strip was wound onto an interior diameter 3 cm paper core at 23° C. and 55 percent relative humidity so that the ink receptive layer faced outward. One hour later, the strip removed, and the ink receptive layer surface was observed employing a hand magnifier. Subsequently, the number of cracks due to bending and fracture was recorded, and the flexibility of the ink receptive layer was evaluated based on the criteria below.

Evaluation Criteria

A: no generation of cracking was noted and the flexibility of the ink receptive layer was excellent

B: generated cracked lines were 1-5, and the flexibility of the ink receptive layer was excellent

C: generated cracked lines were 6-19, and the flexibility of the ink receptive layer was slightly degraded

D: generated cracked lines were 20-99, and the flexibility of the ink receptive layer was poor

E: generated cracked lines were at least 100, and the flexibility of the ink receptive layer was very poor

In the above ranks, rank C or above was judged to be commercial viable.

(Evaluation of Printing Density)

A solid black image was printed on each of the above recording sheets, employing “Ink Jet Printer PM-800C” (manufactured by Seiko Epson Corp.), and the reflection density was determined.

Evaluation Criteria

A: density was at least 2.4, resulting in good commercial viability

B: density was 2.2-2.4, also resulting good commercial viability

C: density was 2.0-2.2, resulting in slightly lowered density, but still at no problems for commercial viability

D: density was less than 2.0, resulting in insufficient density resulting in problems for commercial viability

In the above ranks, rank C or above was judged to be commercial viable.

(Evaluation of Image Bleeding Resistance)

By employing “Ink Jet Printer PM-800C” (manufactured by Seiko Epson Corp.), approximately 0.3 mm wide black lines were printed on the background of a solid magenta image of each of the recording sheets above and left standing for 5 minutes. Thereafter, the resulting prints were stored at 50° C. and 85 percent relative humidity for 5 days. The bleeding of fine lines prior to and after storage was evaluated based on the 4 ranks below.

Evaluation Criteria

A: no bleeding was noted, resulting in excellent appearance

B: very slight bleeding was noted, resulting good appearance

C: slight bleeding was noted, resulting in degradation of appearance

D: bleeding was clearly noted, resulting in definite degradation of appearance

In the above ranks, rank C or above was judged to be commercial viable.

Table 2 shows each of the evaluation results.

TABLE 2

| | | | | Average | EVALUATION | | | | | | |
|---|---|---|---|---|---|---|---|---|---|---|---|
| | Re- | Minute | Minute | Secondary | | | Flexibility | | | Image | |
| | cording | Inorganic | Particle | Particle | | Cracking | of Ink | Ink | | Bleeding | |
| Sample | Sheet | Particles | Dispersion | Diameter | Smooth- | Resis- | Receptive | Absorba- | Printing | Resis- | Re- |
| No. | No. | No. | No. | (nm) | ness | tance | Layer | bility | Density | tance | marks |
| 1 | A-1 | 1 | S-1 | 129 | A | A | B | A | A | A | Inv. |
| 2 | A-2 | 2 | S-2 | 173 | A | A | A | B | B | B | Inv. |
| 3 | A-3 | 3 | S-3 | 191 | A | A | A | B | B | A | Inv. |
| 4 | A-4 | 4 | S-4 | 262 | A | C | C | C | B | A | Inv. |
| 5 | A-5 | 4 | S-5 | 480 | C | B | B | D | C | B | Comp. |
| 6 | A-6 | 5 | S-6 | 188 | A | A | A | C | C | C | Inv. |
| 7 | A-7 | 6 | S-7 | 221 | A | A | A | B | C | C | Inv. |
| 8 | A-8 | 6 | S-8 | 461 | B | C | C | B | C | C | Inv. |
| 9 | A-9 | 7 | S-9 | 231 | A | B | B | A | C | D | Comp. |
| 10 | B-1 | 1 | S-1 | 129 | A | B | C | C | B | A | Inv. |
| 11 | C-1 | 1 | S-1 | 131 | A | B | C | B | A | A | Inv. |
| 12 | D-1 | 3 | S-3 | 192 | A | B | C | B | B | A | Inv. |
| 13 | E-1 | 3 | S-3 | 191 | D | D | E | B | B | A | Comp. |

Inv.; Present Invention
Comp.; Comparative Example

As can clearly be seen from Table 2, recording sheets of the present invention exhibited excellent smoothness, cracking resistance, flexibility of the ink receptive layer, ink absorbability, printing density and image bleeding resistance compared to comparative examples.

Even though a thick porous layer comprised of hydrophilic binders and alumina or alumina hydrate is applied onto a support at a high speed, the recording sheet of the present invention and the production method thereof exhibit excellent effects in which the smoothness and surface appearance are also excellent; no cracking tends to result during production; the flexibility of the ink receptive layer as well as bending and fracture resistance are excellent; the ink absorbability of the ink receptive layer is also excellent, and high printing density is achieved.

1. An ink jet recording sheet comprising a support having thereon an ink receptive layer, wherein the ink receptive layer comprises a porous layer containing alumina particles or alumina hydrate particles and a hydrophilic binder which has undergone crosslinking employing ionization radiation.

2. The ink jet recording sheet of claim 1, wherein the alumina particles or alumina hydrate particles have an average secondary particle diameter of 10 to 300 nm.

3. The ink jet recording sheet of claim 1, wherein the alumina particles or alumina hydrate particles have a specific surface area of 80 to 400 m²/g determined by BET method.

4. The ink jet recording sheet of claim 1, wherein the alumina particles are synthesized via gas phase method.

5. The ink jet recording sheet of claim 1, wherein the support is a non-ink absorptive support.

6. A production method of the ink jet recording sheet of claim 1, which comprises;
applying a dispersion comprising alumina particles or alumina hydrate particles and a hydrophilic binder capable of cross-linking via ionization radiation onto the support to form a coated layer, and
irradiating the coated layer via ionization radiation.

7. A production method of claim 6, wherein
ionization radiation is carried out at an exposure energy of 0.1 to 100 mJ/cm² at a wavelength of 350 nm employing a metal halide lamp having a dominant luminous wavelength of 300 to 400 nm.

8. A production method of claim 6, wherein the hydrophilic binder is water-soluble before ionization radiation and turns water-insoluble via ionization radiation.

9. A production method of claim 8, wherein the hydrophilic binder is a polyvinyl alcohol partially modified with a group capable of crosslinking reaction via ionization radiation.

10. A production method of claim 9, wherein a degree of polymerization of the hydrophilic binder is at least 500 and a modification ratio of a crosslinking group is 0.01 to 4 mol percent based on a total mol of the hydrophilic binder.

11. A production method of claim 9, wherein the group capable of crosslinking reaction via ionization radiation is a photodimerization group, a photodecomposition group, a depolymerization group, a photomodification group or a photopolymerization group.

12. A production method of claim 9, wherein the hydrophilic binder comprises a resin comprising structure of the formula (2) in a polyvinyl alcohol structure, 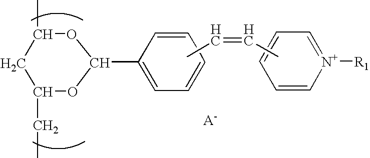
wherein R₁ represents an alkyl group having 1 to 4 carbon atoms and A⁻ represents an anionic group.

13. A production method of claim 12, wherein a molar ratio of the structure of the formula (2) to polyvinyl alcohol structure is 0.01 to 4 percent.

14. A production method of claim 9, wherein the hydrophilic binder comprises a resin comprising structure of the formula (2) in a polyvinyl alcohol structure, 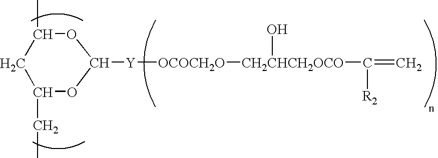
wherein R₂ represents a hydrogen atom or a methyl group, Y represents an aromatic ring or a single bonding means, and n represents 1 or 2.

15. A production method of claim 14, wherein a molar ratio of the structure of the formula (2) to polyvinyl alcohol structure is 0.01 to 4 percent.
